(19) United States
(12) Patent Application Publication
(10) Pub. No.: US 2005/0139202 A1
(43) Pub. Date: Jun. 30, 2005

(54) Oven with forced air circulation

(76) Inventor: Mats Herbert, Taby (SE)

Correspondence Address: PEARNE & GORDON LLP, 1801 EAST 9TH STREET, SUITE 1200, CLEVELAND, OH, 44114-3108, US

(21) Appl. No.: 10/497,512

(22) PCT Filed: Dec. 19, 2002
(86) PCT No.: PCT/EP02/14870

(30) Foreign Application Priority Data
Dec. 21, 2001 (SE) 0104374-4

(51) Int. Cl. F24C 15/32; A21B 1/00

(52) U.S. Cl. 126/21 A

(57) ABSTRACT

An oven for treatment of food comprises an oven chamber (12), means (19, 21, 23) for heating of the air in the oven chamber, and fan means (32) for circulation of the heated air in said chamber. The fan means (32) is a cross-flow fan with an impeller (34) provided to rotate freely without a surrounding fan housing. The impeller (34) is provided with fan blades (42) of a design such that a slowly rotating air jet (49) is created which has a direction of rotation which equals the direction of rotation of the impeller (34). Alternatively, the fan blades (42) may have a design such that a slowly rotating air jet (49) is created with a direction of rotation opposite to that of the impeller (34).

The present invention refers to an oven with forced air circulation comprising an oven chamber and a fan for circulation of heated air in the oven chamber.

In ovens for baking and cooking purposes it is sometimes desirable to be able to place dishes and baking-plates at different levels for simultaneous treatment and so increasing the capacity of the oven. In a traditional oven having heating elements disposed at the top and bottom parts of the oven it may be hard for heat from the lower heating element to reach dishes, cakes, pastry and the like placed on an upper one of, for example, two treatment planes in the oven while, in the same way, it will be hard for heat from the upper heating element to reach articles of food placed on the lower plane. In case of baking-plates, for example, these will effectively screen one another from the heating elements with the result that the treatment time will be very long if at all it would be possible to get a satisfactory result under the conditions described. Hence, in a traditional oven with heating elements placed at the top and bottom, respectively, of the oven, for practical reasons dishes or articles to be baked can be placed in one treatment plane only if a satisfactory result is to be obtained.

In these circumstances it has been suggested that the traditional oven be provided with a fan for circulating heated air in the oven chamber. By this circulation of air it would be possible to distribute the heat in the oven to all places where dishes or articles to be baked are present irrespective of the position of the same in a single or in any of plurality of planes. In a commonly used embodiment of a forced air circulation oven the fan has the form of a centrifugal blower placed adjacent to the rear wall of an oven chamber. The blower sucks air in the centre and blows it radially in a vertical plane at the rear wall. The air is forced past an annular heating element and via adjacent oven walls conveyed out into the oven chamber.

It has turned out that even if a relatively satisfactory result can be obtained as far as the heat distribution is concerned a completely even distribution of heat is out of reach. This is true in particular in domestic ovens where for cost reasons necessary additional arrangements, such as additional fans and special air guides, are not an option.

In the publication Eck B.: Ventilatoren, 5. Aufl., Springer-Verlag Berlin, Heidelberg 1991, p. 194-197 a tangential fan, also called cross flow fan, is described. The fan is of a special design in which a drum-shaped impeller is allowed to rotate freely, i.e. without any guidance of the air by a surrounding fan housing neither at the inlet nor at the outlet side. The impeller is provided with a plurality of fan blades evenly distributed along the periphery of the impeller. When the impeller is rotating air is driven into the interior of the impeller and out therefrom via openings between the fan blades. In a fan so designed a phenomenon appears in the form of a strongly pronounced jet which by itself rotates slowly about the axis of rotation of the fan. The rotational speed of the jet depends on the angular setting of the fan blades and the jet can rotate in the same direction as the impeller or in the opposite direction.

From tests carried out with a cross flow fan of the design just described and applied in a forced air circulation oven for circulation of heated air therein it has turned out that it is possible to obtain an improved distribution of the heated air in the oven chamber. This is achieved by the slowly rotating jet, which can also be seen as a slowly rotating big air whirl, generated by the fan. Thereby the formation of areas of elevated temperature in the oven chamber is reduced or even eliminated.

Accordingly, the object of the invention is to obtain an improved distribution of heated air in an oven with forced air circulation by making use of the particular characteristics of the cross flow fan described above. The object is achieved in an oven which has obtained the characteristic features indicated in the appending claim 1. Preferred embodiments have been included in the associated sub-claims.

The invention will now be described more in detail in connection with an embodiment with reference to the appending drawings.

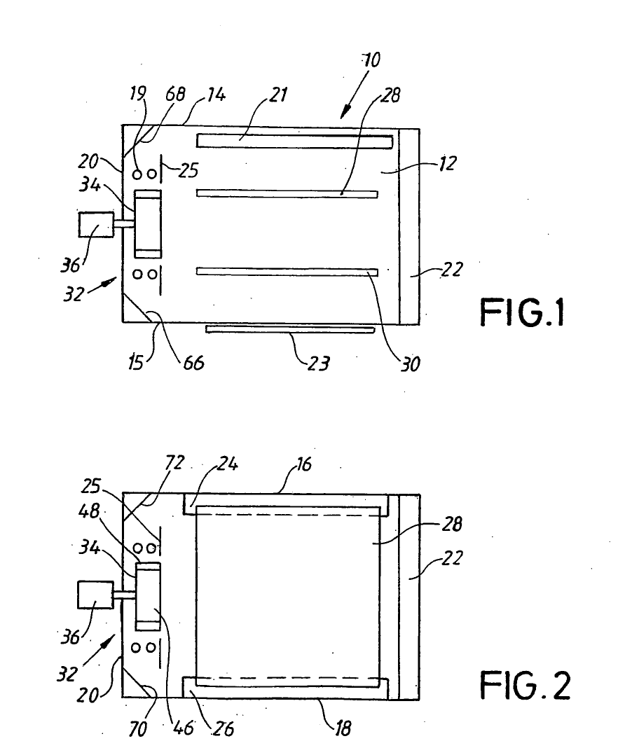

FIGS. 1 and 2 show an oven for domestic use having forced air circulation. The oven comprises a cross-flow fan adapted to generate a hot air stream in the oven. The oven 10 comprises an oven chamber 12 defined by an upper wall 14, a lower wall 15, side walls 16, 18 and a rear wall 20. The oven chamber 12 has an opening, at the front side thereof, which is closable by means of a door 22. Customary rails 24, 26 are provided in the oven chamber 12 on which baking plates 28, 30 can be supported at predetermined levels. In the oven chamber the air is heated in a traditional way by means of electric elements the nature and positioning of which will be described more in detail below.

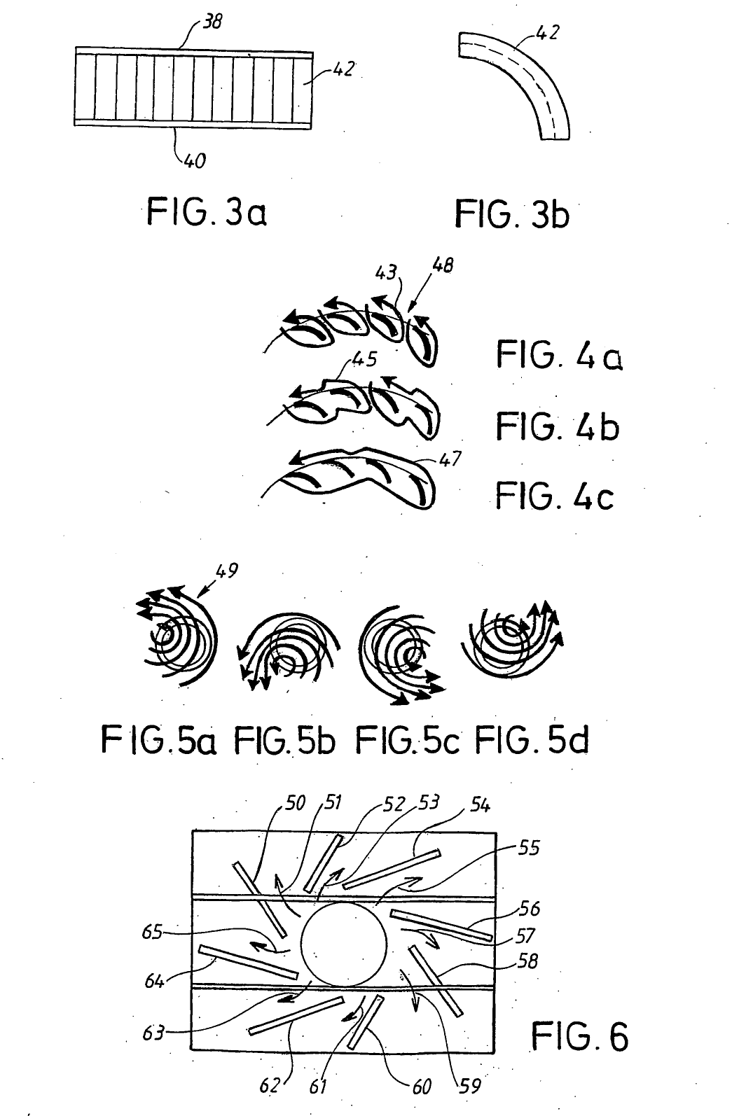

At the rear wall 20 a fan 32 of the cross-flow type is provided which comprises an impeller 34 driven by an electric motor 36. The impeller has the shape of a short cylinder with side walls 38, 40 and a plurality of fan blades 42 distributed along the pheriphery 44 of the cylinder, said fan blades 42 being curved in the direction of rotation of the impeller, see FIG. 3a, 3b.

As indicated, the fan is of the cross-flow type in which air is led into and out from the impeller 34 via openings 48 formed between the fan blades 42. As shown in FIG. 4a, when the impeller rotates air escaping through one of said openings 48 will leak back into the interior of the impeller via an adjacent opening along the periphery of the impeller thereby generating a whirl around each fan blade 42, as indicated by the arrow 43. These air whirls are combined into a whirl 45 around two adjacent fan blades 42, as shown in FIG. 4b, and the formation of whirls goes on, as indicated by the arrow 47 in FIG. 4c for four fan blades, until one single large whirl 49 (FIG. 5a-d) has been formed which extends along the whole of the periphery of the impeller 34. Due to the fact that no fan housing or other obstacle is present adjacent to the impeller 34 the large whirl 49 will not be bound to any fixed direction and in the typical case it will rotate at a speed considerably lower than that of the impeller. The rotation of the whirl or air jet 49 is shown in the series of FIGS. 5a-5d and the ratio between the rotational speed of the jet and that of the impeller is about 1:20. The rotational speed of the air jet expressed as a pulse frequency is about 2 Hz in the case referred to. By variation of the blade angle of the fan blades 42 with respect to the direction of the tangent of the pheripheral surface of the impeller the pulse frequency can be changed both upwards and downwards and even take negative values, which means that the air jet 49 rotates in the opposite direction as the impeller 34. A preferred value of the pulse frequency is about 1 Hz which in the application indicated has proved to provide effective stirring and distribution of the warm air circulating in the oven.

A common problem in a classical oven with forced air circulation is associated with the simultaneous baking of buns placed on two baking plates disposed at different levels in the oven. FIG. 1 shows the two plates 28 and 30 supporting buns, not shown, which are evenly distributed on the repective plate. By means of the cross-flow fan 32, described above, a turbulent air flow is generated which sweeps along the plates 28, 30, both on the underside and on the overside where the buns are placed, from the rear wall 20 of the oven chamber in a direction towards the oven door 22. The turbulent flow, which is created by the slowly rotating air jet 49 from the fan 32 causes the warm air to approach the buns on the plates 28, 30 from different directions and as a result the buns will be evenly baked without the creation of burnt or too light areas.

In FIG. 6 the oven chamber 12 is shown in a front view. The air from the fan 32 is being thrown out radially in a vertical plane parallel to the rear wall 20 and there is a tendency that, to a high extent, the air is deviated towards the corners formed by the rear wall 20, the upper wall 14, the lower wall 15 and the adjacent side walls 14, 16. This means a more concentrated air flow past the plates 28, 30 in areas of the corners which may cause the buns most close to said corner areas to reach a too high temperature as compared to the remining buns on the plates so that there is a risk for the corner buns to be burnt. In order to solve the problem a plurality of guide plates 50, 52, 54, 56, 58, 60, 62, 64 are provided, suitably on the rear wall 20, the purpose of which is to divide the flow into different streams 51, 53, 55, 57, 59, 61, 63, 65 so that a reduced part of the flow is led towards the corners in favour of intermediate areas along the limiting walls of the oven chamber.

As shown in FIGS. 1 and 2, the transitions between the walls at the rear part of the oven adjacent the fan 32 have been modified in order to achieve a softer deviation of the air flow in the direction towards the oven door 22. This has been achieved by guide plates 66, 68, 70, 72 provided in the transitions between adjacent walls at the rear part of the oven chamber. As a result the air jet 49 from the impeller 34 will rotate more evenly and the risk for the air jet 49 to be locked in a any specific direction will be reduced. In the practical case the transitions between adjacent walls in the rear part of the oven chamber can be brought about by giving the transitions between the rear wall 20 and the adjacent walls a suitable curved shape during the manufacturing process.

As indicated above heating of the air in the oven 10 takes place by means of electrical heating elements and in FIG. 1 an annular heating element 19 is shown to surround the impeller 34. In order to prevent direct radiation from the annular heating element 19 onto food on the plates 28, 30 a shield plate 25 is provided.

In case the oven air is to be heated by means of the element 19 alone this element should have a rated power of 2500 W for the temperature levels and loads to be handled by the oven. In order to achieve a more favourable heat distribution with a reduced risk of areas of elevated temperature to appear the oven is provided with an upper heating element 21 and a lower heating element 23. If the power of the element 19 is reduced to about 1500 W and the rating of the elements 21 and 23 is chosen to about 500 W the available power will remain unchanged while the temperature of the air in the rear part of the oven will decrease. Another way of obtaining a reduction of the temperature of the air in the rear part of the oven is to use an annular element 19 having a reduced diameter so that the outlet opening of the air stream between the annular element 19 and the adjacent oven walls increases. This gives a lower air velocity which causes a lower heat transfer to the load most close to the fan 32. A reduction of the diameter of the annular element 19 may need to be accompanied by other modifications due to the fact that, most likely, the pulse frequency will be affected by this modification of the annular element.

As a summary, it can be pointed out that the application of a cross-flow fan in an oven in the way described will give a considerably more even temperature distribution in the oven wherein a spread load, for example in the form of buns disposed on plates at different levels in the oven chamber, will be exposed to an essentially uniform heating effect in all points.

1. Oven for treatment of food, comprising an oven chamber (12), means (19, 21, 23) for heating of the air in the oven chamber, and fan means (32) for circulation of the heated air in said chamber, characterized in that the fan means (32) is a cross-flow fan with an impeller (34) provided to rotate freely without a surrounding fan housing, said impeller (34) being provided with fan blades (42) of a design such that an air jet (49) is created which rotates at a considerably lower speed compared to that of the impeller (34).

2. Oven according to claim 1, characterized in that the fan blades (42) are designed so that the rotating air jet (49) has a direction of rotation which equals the direction of rotation of the impeller (34).

3. Oven according to claim 1, characterized in that the fan blades (42) are designed so that the rotating air jet (49) has a direction of rotation which is opposite to the direction of rotation of the impeller (34).

4. Oven according to any of claims 1-3, characterized in that the oven chamber (12) has essentially the shape of a parallelepiped comprising side walls (16, 18), a rear wall (20), and a front opening closable by means of a door (22), wherein the cross-flow fan (32) is disposed at the rear wall (20) so that the air jet (49) is driven to rotate in a vertical plane.

5. Oven according to claim 4, characterized in that, at the rear wall (20) a plurality of guide plates (50, 52, 54, 56, 58, 60, 62, 64) are provided for dividing the rotating air jet (49) into a corresponding number of part air jets (51, 53, 55, 57, 59, 61, 63, 65) which are deviated in the direction towards the oven door (22) by means of the rear wall (20) and adjacent side walls (14, 15, 16, 18) in the oven chamber (12).

6. Oven according to claim 5, characterized in that for soft deviation of the part air jets (51, 53, 55, 57, 59, 61, 63, 65) guide plates (66, 68, 70, 72) or the like are provided between the rear wall (20) and the adjacent side walls (14, 15, 16, 18), wherein the angle between the guide plates (66, 68, 70, 72) and the respective side wall is about 45°.

7. Oven according to claim 5, characterized in that for a soft deviation of the part air jets (51, 53, 55, 57, 59, 61, 63, 65) the transitions between the rear wall (20) and the adjacent side walls (14, 15, 16, 18) have been given a suitable radius.

8. Use in an oven for treatment of food of a cross-flow fan (32) with an impeller (34) provided to rotate freely without a surrounding fan housing, said impeller (34) being provided with fan blades (42) of a design such that an air jet (49) is created which rotates at a considerably lower speed compared to that of the impeller (34).
